(19) United States
(12) Patent Application Publication
(10) Pub. No.: US 2010/0012557 A1
(43) Pub. Date: Jan. 21, 2010

(54) SEPTIC TANK WASTEWATER TREATMENT SYSTEM

(76) Inventor: Kevin R. Chaffee, Batesville, IN (US)

Correspondence Address: INNOVATION LAW OFFICE OF DENNIS SCHELL, 133 WEST MARKET STREET # 256, INDIANAPOLIS, IN, 46204, US

(21) Appl. No.: 12/523,859

(22) PCT Filed: Jan. 20, 2008
(86) PCT No.: PCT/US2008/051534

§ 371 Date: Jul. 20, 2009

Related U.S. Application Data
(60) Provisional application No. 60/881,623, filed on Jan. 20, 2007.
(60) Provisional application No. 60/926,257, filed on Apr. 26, 2007.

(51) Int. Cl. B01D 12/00; B01D 21/30; B01D 21/34; C02F 1/20

(52) U.S. Cl. 210/86; 210/532.2; 210/521; 210/137; 210/188

(57) ABSTRACT

A simple and improved septic tank wastewater treatment system is needed to improve effluent quality and reduce conventional onsite system failures such as hydraulic overloading and formation of a clogging biomat in the soil treatment area. One illustrative embodiment of the septic tank system (10, 100, 122) disclosed includes a septic tank system having a primary treatment compartment (28, 116) for settling solids and floating fats, oils and grease, and a second treatment compartment (34, 141) adapted to provide an upflow anaerobic sludge blanket (UASB) process for providing additional treatment of the wastewater prior to discharge to soil treatment areas. Another illustrative embodiment of the septic tank system includes separate primary (100) and UASB tanks (122) coupled in series.

### CROSS-REFERENCE TO RELATED APPLICATIONS

This application claims the benefits of U.S. Provisional Patent Applications Ser. No. 60/881,623, filed Jan. 20, 2007 and titled ADVANCED SEPTIC TANK WASTEWATER TREATMENT APPARATUS, and Ser. No. 60/926,257, filed Apr. 26, 2007 and titled ADVANCED SEPTIC TANK TREATMENT APPARATUS, both of which are incorporated herein by reference.

### BACKGROUND

The present invention relates to wastewater treatment systems, and more specifically, to septic tank wastewater treatment systems.

The invention of the septic tank is credited to Frenchman John Louis Mouras, who during the 1860s constructed a masonry tank into which he discharged the sewage from his dwelling in Vesoul, France. After about a dozen years, the tank was opened and found to be almost free of solids. Mouras eventually approached a scientist of the era and was able to patent his invention on Sep. 2, 1881. It is believed that the septic tank was initially introduced to the United States in 1883, and by the late 1880's, septic tanks similar in concept to those used today were in common use. Even now, over 125 years later, septic tanks still represent a major domestic wastewater treatment option, and are little changed from their initial design.

Conventional residential septic tanks generally consist of a concrete, fiberglass or polyethylene tanks of between 750 and 1,500 gallons (2,800 and 5,700 liters). Commercial septic tanks typically range between 750 and 50,000 gallons (2,800 and 190,000 liters) or more. The design of the tank typically incorporates one or two compartments and has an inlet pipe at one end and an outlet pipe on the other. Wastewater enters the tank and solids (and denser materials) settle to the bottom and lighter (less dense) scum floats to the surface of the wastewater. The settled solids are anaerobically digested over time, reducing the volume of solids. The liquid from the center zone of the tank flows through an outlet tee or filter and is typically discharged to a soil treatment area for additional treatment prior to groundwater recharge.

Wastewater is conveyed into the septic tank via an inlet pipe. The septic tank compartment is large in comparison to the conveyance piping so that flow velocity is substantially decreased, which allows the solid materials in the wastewater to settle to the bottom of the tank, and the fats, oils and grease to float to the surface. The outlet pipe is configured so that effluent leaving the tank is drawn from the center “clear zone” between the settled sludge and the floating scum. The conventional septic tank typically has access openings over the inlet and outlet pipes and over multiple compartment walls to allow for service and pumping of the tank when the solids or scum levels become excessive.

The conventional septic tank has no moving parts nor requires any mechanical equipment or electrical power to operate. The conventional septic tank treats the wastewater by removing the settleable solids and floatable materials by gravity and by reduction of the organic materials by anaerobic microorganisms within the tank. Anaerobic microorganisms function in the absence of oxygen, as compared to aerobic microorganisms which require an input of oxygen to survive and provide treatment of wastewater. The typical conventional septic tank provides reduction of biochemical oxygen demand (BOD), a measurement of the organic strength of the wastewater, of about 30-60%, reducing typical domestic strength wastewater from about 300 milligrams per liter (mg/l) to about 150 mg/l (30 day average). The typical conventional septic tank provides reduction of total suspended solids (TSS), a measurement of the amount of solid material suspended in the wastewater, of about 60-90%, reducing typical domestic strength wastewater from about 300 mg/l to about 75 mg/l (30 day average).

The septic tank is part of a conventional onsite wastewater system (OWS) which includes the septic tank and soil treatment area. According to the U.S. EPA Onsite Wastewater Treatment Systems Manual, approximately 23 percent of the estimated 115 million occupied homes in the United States are served by OWSs, a proportion that has changed little since 1970. More than 60 million people depend on OWSs, including the residents of about one-third of new homes and more than half of all mobile homes nationwide.

Conventional OWSs generally perform acceptably if they are installed in areas with appropriate soils, are not hydraulically overloaded or subjected to excessive solid or organic loadings, installed properly, and maintained to ensure long-term performance. These criteria, however, are often not met.

Only about one-third of the land area in the United States has suitable soils for conventional subsurface soil treatment areas. System densities in some areas exceed the capacity of even suitable soils to assimilate wastewater flows and retain and transform their contaminants. In addition, many systems are located too close to ground water or surface waters and others are not designed to handle actual flows. Public health can be affected if wastewater backs up into residences because of OWS failure.

According to the U.S. EPA Onsite Wastewater Treatment Systems Manual, a number of OWSs still rely on outdated and poorly performing technologies. Moreover, about half of the occupied homes with OWSs are more than 30 years old, with a significant number of the older systems reporting problems. A survey conducted by the U.S. Census Bureau estimated that over 400,000 homes experienced OWS failures within a 3-month period during 1997. Studies reviewed by USEPA cite overall failure rates ranging from 10 to 20 percent or greater. System failure surveys typically do not include systems that might be contaminating surface or ground water, a situation that often is detectable only through site-level monitoring.

Two of the primary causes of conventional OWTS failure are hydraulic overloading and soil plugging due to a clogging biomat. Hydraulic overloading occurs when a larger amount of water flows into a subsurface soil treatment area than can be moved by gravity through the soil. The soil becomes saturated and effluent is forced to the surface without being adequately treated. In extreme situations, wastewater can back up in the septic tank and into the home. Poorly drained soils, high periods of water use, improper design/construction, or leaky septic tanks can cause hydraulic overloading.

Septic tanks provide primary wastewater treatment by separating solid and floating materials from the semi-clear effluent. Even when outlet filters are used, the resulting effluent typically remains high in BOD and TSS. The BOD and TSS are discharged to the subsurface soil treatment area where they form an anaerobic layer or “biomat” within the soil. This biomat may restrict flow into the soil (a clogging biomat) which forces the effluent to backup or surface without adequate treatment.

Several studies have shown that pretreatment of septic tank effluent prior to soil disposal dramatically reduces the failure rate of conventional onsite systems. Converse and Tyler evaluated the effect of highly pretreated effluent on soil loading rates and separation distances to groundwater and/or limiting layers. Field data was collected from a number of septic tanks followed by advanced pretreatment units. These advanced pretreatment units, such as sand filters, recirculating sand filters, peat filters, and aerobic treatment units, reduced BOD and TSS allowing higher soil loading rates than if septic tank effluent was applied directly.

Based on the many studies showing the positive effects of increased treatment prior to subsurface soil dispersal, it is apparent that conventional onsite system failure can be dramatically reduced by improved treatment and higher quality effluent being discharged to the soil. Better treatment will allow higher soil loading rates which will reduce hydraulic overloading. Better treatment will also substantially reduce the formation of a clogging biomat in the soil treatment area by reducing BOD and TSS in the effluent applied to the soil.

The onsite wastewater industry has accepted the concept of improved treatment and there are a number of available technologies to provide higher quality treatment of septic tank effluent prior to subsurface soil dispersal. Aerobic treatment units, media filters, and constructed wetlands are all common onsite wastewater treatment technologies which have been available for several years. These systems have not been widely used due to their complexity, cost, and extensive maintenance requirements. Based on available data, over 92% of all permitted onsite wastewater systems in the U.S. are still conventional septic systems.

Based on this information, it is apparent that a simple, inexpensive, improved septic tank is needed to improve effluent quality and reduce conventional onsite system failures. As previously stated, the conventional septic tank typically provides reduction of biochemical oxygen demand (BOD), a measurement of the organic strength of the wastewater, of about 30-60%, reducing typical domestic strength wastewater from about 300 milligrams per liter (mg/l) to about 150 mg/l (30 day average). The conventional septic tank typically provides reduction of total suspended solids (TSS), a measurement of the amount of solid material suspended in the wastewater, of about 60-90%, reducing typical domestic strength wastewater from about 300 mg/l to about 75 mg/l (30 day average). Actual performance testing of the septic tank wastewater treatment apparatus described herein has shown a reduction of BOD of over 81%, and a reduction of TSS of over 95%.

### SUMMARY

The present invention may comprise one or more of the features recited in the attached claims, and/or one or more of the following features and combinations thereof.

In accordance with one illustrative embodiment, a septic tank comprises a primary compartment for settling solids and floating fats, oils and grease, and a second compartment comprising an upflow anaerobic sludge blanket (UASB) process for providing additional treatment of the wastewater prior to discharge to soil treatment areas. In another illustrative embodiment, separate primary and UASB tanks in series are provided to comprise the system.

The definition of “compartment” and “basin” as used herein includes a space defined so as to limit fluid flow entering or exiting the space to a desired location or area, and/or to a desired flow rate, including a space that is substantially partitioned off from another space defined in the same vessel.

The definition of “inlet” and “outlet” as used herein includes any path or conveyance known in the art that provides fluid communication between two spaces, including a conduit, baffle, gateway or other opening, whether or not such path or conveyance includes a restriction such as a valve, screen, or filter material, or includes fluid propulsion, for example, a pump.

The definition of “solids” as used herein includes matter that gravity tends to settle from water, including dirt particles and materials denser than water.

The definition of “scum” as used herein includes matter that gravity tends to settle water below, thereby floating the matter, including fats, oils, grease, and other materials less dense than water.

The definition of “pipe” as used herein includes conduits having circular and non-circular cross-sections perpendicular to the longitudinal axis of the pipe.

One illustrative embodiment of a septic tank system for treating wastewater comprises a primary treatment compartment having a first inlet for receiving the wastewater and a first outlet for discharging wastewater, the primary treatment compartment adapted to separate from the wastewater therein a portion of at least one of solids and scum; and second treatment compartment having a second inlet and a second outlet, the second inlet coupled to the first outlet of the primary treatment compartment; wherein the second treatment compartment is adapted to provide an upflow anaerobic sludge blanket (UASB) wastewater treatment process. The system can further comprise a discharge means coupled to the second inlet and adapted to distribute wastewater adjacent a bottom portion of the second treatment compartment. The system can further comprise a septic tank and wherein the first treatment compartment and the second treatment compartment are defined in the septic tank by at least one dividing wall therebetween. The system can further comprise a first septic tank having the first treatment compartment defined therein; and a second septic tank having the second treatment compartment defined therein. The discharge means can comprise a pipe spanning a substantial length of the bottom portion of the second treatment compartment, the pipe having an outer wall and a plurality of spaced openings defined through the outer wall. The openings can be located at about the 3 and 9 o'clock position as viewed in a cross-section oriented perpendicular to the longitudinal axis of the pipe. The pipe can be about 3 to 4 inches (7.6 to 10.2 cm) across in cross-section perpendicular to the longitudinal axis of the pipe, and the openings can be about ¾ to 1 inch (1.9 cm to 2.5 cm) across. The pipe can include a first vertical section, the first vertical section extended upwardly away from the bottom of the second treatment compartment and terminating at a first end positioned at a level above that of a invert of the second outlet, the first end adapted to provide gas venting and cleaning of the pipe. The first end can be position adjacent the second inlet of the second treatment compartment. The pipe can include a second vertical section at an end of the pipe opposite the first vertical section, the second vertical section extended upwardly away from the bottom of the second treatment compartment and terminating at a second end positioned at a level above that of the invert of the second outlet, the second end adapted to provide gas venting and cleaning of the pipe. The second end can be position proximate the second outlet of the second treatment compartment. The system can further comprise an outlet filter coupled to the first outlet of the first treatment compartment. The system can further comprise an outlet filter coupled to the second outlet of the second treatment compartment. The outlet filter can include a flow control orifice. The system can further comprise a wastewater level alarm for at least one of the first treatment compartment and the second treatment compartment.

Another illustrative embodiment of a septic tank system for treating wastewater, comprises a primary treatment compartment having a first inlet for receiving the wastewater and a first outlet for discharging wastewater, the primary treatment compartment adapted to separate from the wastewater therein a portion of at least one of solids and scum; a second treatment compartment having a second inlet and a second outlet, the second inlet coupled to the first outlet of the primary treatment compartment; and a discharge manifold coupled to the second inlet and adapted to distribute wastewater adjacent a bottom portion of the second treatment compartment. The system can further comprise a septic tank and wherein the first treatment compartment and the second treatment compartment are defined in the septic tank by at least one dividing wall therebetween. The system can further comprise a first septic tank having the first treatment compartment defined therein; and a second septic tank having the second treatment compartment defined therein.

Yet another illustrative embodiment of a septic tank system for treating wastewater, comprises a primary treatment compartment having a first inlet for receiving the wastewater and a first outlet for discharging wastewater, the primary treatment compartment adapted to separate from the wastewater therein a portion of at least one of solids and scum; a second treatment compartment having a second inlet and a second outlet, the second inlet coupled to the first outlet of the primary treatment compartment; a discharge pipe spanning a substantial length of the bottom portion of the second treatment compartment, the pipe having an outer wall and a plurality of spaced openings defined through the outer wall, the pipe including a first vertical section, the first vertical section terminating at a first end positioned at a level above that of the wastewater level, the first end adapted to provide gas venting and cleaning of the pipe; a first outlet filter coupled to the first outlet of the first treatment compartment; and a second outlet filter coupled to the second outlet of the second treatment compartment. The system can further comprise a first septic tank having the first treatment compartment defined therein; and a second septic tank having the second treatment compartment defined therein.

Additional features of the present disclosure will become apparent to those skilled in the art upon consideration of the following description of illustrative embodiments.

### BRIEF DESCRIPTION OF THE DRAWINGS

The description of illustrative embodiments particularly refers to the accompanying figures in which:

FIG. 1 is a perspective view of an illustrative embodiment a septic tank system according to the present disclosure;

FIG. 2 is a top, side perspective view of the illustrative embodiment of FIG. 1 with the lid removed;

FIG. 3 is a top, first end perspective view of the illustrative embodiment of FIG. 1 with the lid removed;

FIG. 4 is a top, second end perspective view of the illustrative embodiment of FIG. 1 with the lid removed;

FIG. 5A is an end perspective view of the illustrative embodiment of FIG. 1 with the lid raised;

FIG. 5B is a side perspective view of the illustrative embodiment of FIG. 1 with the lid raised;

FIG. 6 is a detailed side perspective view of the outlet filter with flow control orifice of the illustrative embodiment of FIG. 1;

FIG. 7 is a perspective view of a second illustrative embodiment of a septic tank system according to the present disclosure, the system having two tanks;

FIG. 8 is a top perspective view of the illustrative embodiment of FIG. 7 with the lid removed;

FIG. 9A is a top perspective view of the primary tank of the illustrative embodiment of FIG. 7; and

FIG. 9B is a top perspective view of the UASB tank of the illustrative embodiment of FIG. 7.

TABLE 1
Drawing Reference Numerals:

| No. | Description |
|---|---|
| 10 | Septic Tank System |
| 12 | Tank Walls |
| 14 | Tank Bottom |
| 16 | Tank Lid |
| 18 | Inlet Pipe |
| 20 | Inlet Tee |
| 22 | Inlet Tee Access Opening and Riser |
| 24 | Inlet Tee Access Opening Riser Lid |
| 26 | Interior Compartment Divider Wall |
| 28 | Primary Treatment Compartment |
| 30 | Primary Treatment Compartment Outlet Filter |
| 32 | Primary Treatment Compartment Outlet Pipe |
| 34 | Upflow Anaerobic Sludge Blanket (UASB) Compartment |
| 36 | Primary Treatment Outlet Filter and UASB Compartment Access |
| | Opening and Riser |
| 38 | Primary Treatment Outlet Filter and UASB Compartment Access |
| | Opening Riser Lid |
| 40 | UASB Compartment Inlet Pipe |
| 42 | UASB Compartment Discharge Pipe |
| 44 | UASB Compartment Discharge Pipe Openings |
| 46 | UASB Compartment Outlet Filter |
| 48 | UASB Compartment Outlet Pipe |
| 50 | Outlet Pipe Flow Control Orifice |
| 52 | Treated Effluent Discharge Pipe |
| 54 | High Water Alarm Float Switch |
| 56 | High Water Alarm Transmitter |
| 100 | Primary Treatment Tank |
| 102 | Primary Treatment Tank Walls |
| 104 | Primary Treatment Tank Bottom |
| 106 | Primary Treatment Tank Lid |
| 108 | Primary Treatment Tank Inlet Pipe |
| 110 | Inlet Tee |
| 111 | Primary Treatment Tank Inlet Access Opening and Riser |
| 112 | Primary Treatment Tank Inlet Access Opening Riser Lid |
| 113 | Primary Treatment Tank Outlet Access Opening and Riser |
| 114 | Primary Treatment Tank Outlet Access Opening Riser Lid |
| 116 | Primary Treatment Basin |
| 118 | Primary Treatment Basin Outlet Filter |
| 120 | Primary Treatment Basin Outlet Pipe |
| 122 | Upflow Anaerobic Sludge Blanket (UASB) Tank |
| 124 | Piping between Primary Treatment Tank and UASB Tank |
| 126 | UASB Tank Walls |
| 128 | UASB Tank Bottom |
| 130 | UASB Tank Lid |
| 132 | UASB Tank Inlet Access Opening and Riser |
| 134 | UASB Tank Inlet Access Opening Riser Lid |
| 136 | UASB Tank Outlet Access Opening and Riser |
| 138 | UASB Tank Outlet Access Opening Riser Lid |
| 140 | UASB Tank Inlet Pipe |
| 141 | UASB Basin |
| 142 | UASB Basin Influent Pipe |
| 144 | UASB Basin Discharge Pipe |
| 146 | UASB Basin Discharge Pipe Openings |
| 150 | UASB Basin Outlet Pipe |
| 152 | Treated Effluent Discharge Pipe |

### DESCRIPTION OF THE ILLUSTRATIVE EMBODIMENTS

For the purpose of promoting and understanding the principals of the invention, reference will now be made to one or more illustrative embodiments illustrated in the drawings and specific language will be used to describe the same.

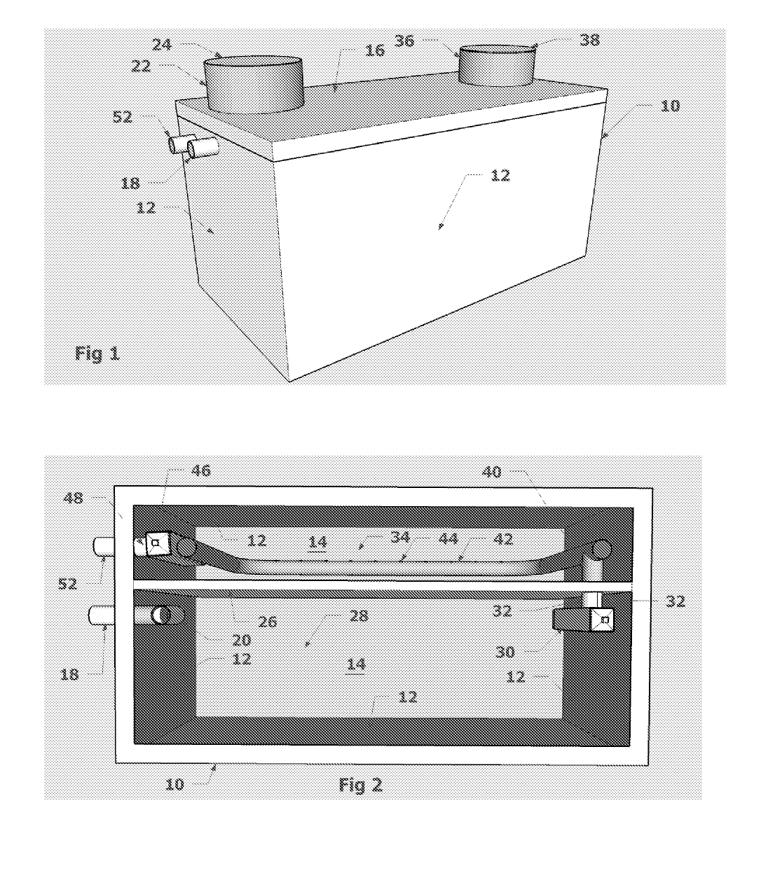

One illustrative embodiment of a septic tank system according to the present disclosure is shown in FIGS. 1-6. Septic tank system 10 is generally installed at the site of the residence or other building, at a specified distance from the building as required by local codes or plumbing regulations. System 10 includes a fully or substantially enclosed vessel constructed of standard septic tank materials such as precast concrete, fiberglass, or plastic, and includes tank walls 12, tank bottom 14, tank lid 16, and other components as described below.

Referring to FIG. 1, system 10 is typically buried below grade so as to allow flow by gravity from the building to the tank. Domestic wastewater from the building flows into influent pipe 18 and falls through the inlet tee 20 into a primary treatment compartment 28. The drop depth of inlet tee 20 is sized so that the untreated wastewater enters a primary treatment compartment 28 below a scum layer located at the top of the wastewater located in compartment 28, and above accumulated sludge located at the bottom of the tank. Tank lid 16 includes an access opening and riser 22 with lid 24, generally located over inlet tee 20 to allow access for service of the tee if it becomes clogged and to allow access for evacuation pumping of the primary treatment compartment 28 when required. Access riser lids, including lid 22, are typically situated at ground level, are fastened in place to prevent unauthorized access, and are sealed to prevent the release of gas or odors to the atmosphere.

Referring to FIG. 2, primary treatment compartment 28 is formed within the tank of system 10, for example, by an integral interior compartment divider wall 26, and portions of tank walls 12, tank bottom 14, and tank lid 16. Interior divider wall 26 is sealed throughout its length with tank walls 12, bottom 14, and optionally lid 16, so as to prohibit fluid transfer from primary treatment compartment 28 to other areas of system 10 other than through specific pathways described below. Primary treatment compartment 28 is sized to provide about 24 hours of wastewater detention. For example, if the system 10 is sized to handle 450 gallons per day (1700 liters per day), then primary treatment compartment 28 will be sized to hold at least about 450 gallons (1700 liters).

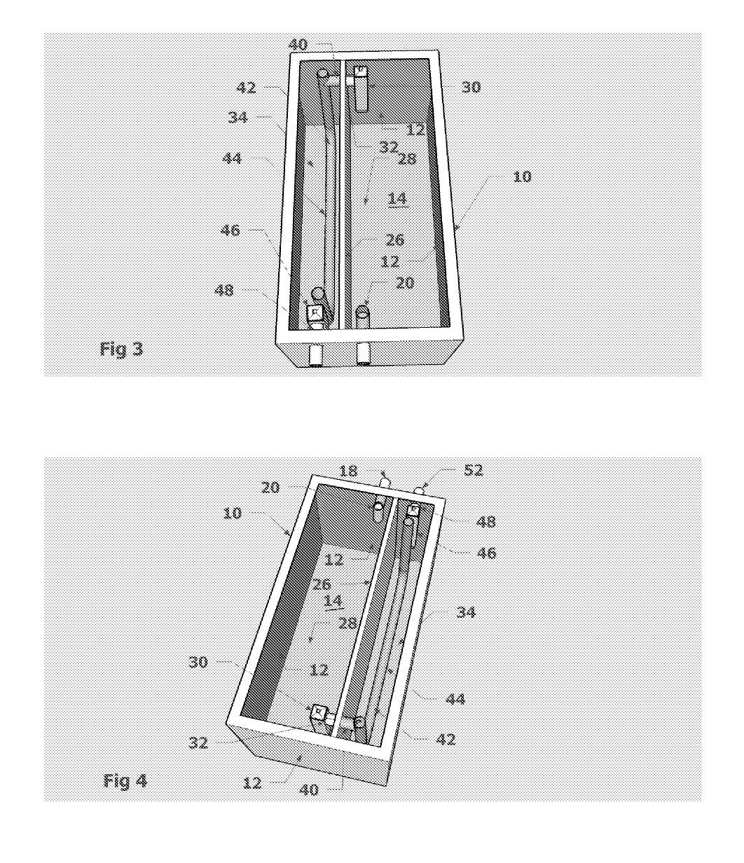

Referring to FIGS. 3 and 4, wastewater entering primary treatment compartment 28 through inlet tee 20 flows laterally through the compartment to the primary treatment compartment outlet filter 30. Water depth in the primary treatment compartment is controlled by the invert elevation of the primary treatment compartment outlet pipe 32, which is typically about 1 to 3 inches (2.5 to 7.6 cm) lower than the invert of the inlet pipe 18.

An access opening and riser 36 with lid 38 is located generally over primary treatment compartment outlet filter 30 to allow access for service of the filter when it becomes clogged and to allow for evacuation pumping of the primary treatment compartment 28 when required. Settleable solids, such as those significantly denser than water, fall to the bottom of the primary treatment compartment 28 by gravity as wastewater flows the length of the compartment, forming a sludge layer, and lighter material significantly less dense than water, such as fats, oils and grease, float to the surface of the water, forming a scum layer. The region between the sludge layer and the scum layer is the center clear zone. The primary treatment compartment 28 thus utilizes the differential density of materials in the wastewater to remove settleable and floatable materials from the wastewater to provide preliminary treatment and prevent these materials from negatively impacting further treatment processes.

The vertical length of outlet filter 30 extends sufficiently downward into the primary treatment compartment 28 so that an inlet opening located at the bottom of filter 30 receives only water from the center clear zone of the tank. The outlet filter 30 includes, for example, slots or other openings of a specific opening size so that no materials larger than the opening size may pass through it. An example effluent outlet 30 filter is the PL-122, available from Polylok, Inc., of Wallingford, Conn., US, which has 1/16 inch (1.6 mm) slots to screen solids from the wastewater passing through.

Filtered wastewater passing from outlet filter 30 flows through primary treatment compartment outlet pipe 32 which passes through the interior compartment divider wall 26 and into an upflow anaerobic sludge blanket (UASB) compartment 34. The illustrative system 10 does not provide for recycle of wastewater or other materials from UASB compartment 34 back to the primary treatment compartment 28; however, alternative embodiments may include this feature. UASB compartment 34 can be defined, for example, by divider wall 26 and portions of tank walls 12, tank bottom 14, and tank lid 16. UASB compartment 34 is sized to provide about 24 hours of wastewater detention. For example, if the system 10 is sized to handle 450 gallons per day (1700 liters per day), then UASB compartment 34 will be sized to hold at least about 450 gallons (1700 liters).

Outlet pipe 32 is coupled to or integral with a USAB compartment influent (inlet) pipe 40. Influent pipe 40 is further coupled to or integral with UASB discharge pipe 42. Therefore, wastewater enters the UASB compartment 34 through UASB compartment influent pipe 40 and flows into UASB compartment discharge pipe 42. Openings 44 are defined in UASB compartment discharge pipe 42 along a substantial central portion of discharge pipe 42 that is positioned adjacent tank bottom 14 in UASB compartment 34. The openings 44 provide discharge of wastewater across a substantial portion of the bottom 14 of the UASB compartment 34.

For a typical septic tank sized for residential applications, the discharge pipe 42 can be a PVC pipe having about a 3 to 4 inch (7.6 to 10.2 cm) diameter. The discharge pipe openings 44 are typically about ¾ inch to 1 inch (1.9 cm to 2.5 cm) circular openings in the wall of discharge pipe 42 and are typically located at the 3 o'clock and 9 o'clock positions along the pipe length; however, alternative opening sizes and shapes can be used. Alternative means of discharging wastewater adjacent the bottom 14 of the UASB compartment 34 includes one or more outlet, manifold, screen, baffle, and other such distributors of fluids and suspended solids.

Opposite ends of UASB discharge pipe 42 extend upward to a level above the normal water depth in the UASB compartment 34 and are open to allow air venting during fluid flow and to allow rodding and other maintenance of discharge pipe 42 and openings 44. An access opening and riser 36 with lid 38 is generally located over UASB compartment inlet pipe 40 to allow access for the servicing and evacuation pumping of the UASB compartment 34 when required.

The filtered wastewater flows upwards out of the discharge pipe openings 44 defined in the UASB compartment discharge pipe 42. Over time, granular sludge particles collect over the discharge pipe 42 and across the floor 14 of the UASB compartment 34. The filtered wastewater discharged from pipe openings 44 flows by head pressure from the elevation of the water depth in the UASB compartment 34 through the granular sludge particles and is thereby treated biologically by a physical and chemical process including anaerobic microorganisms that comprise the sludge particles. An early apparatus utilizing a UASB process for industrial wastewater treatment was described by Dr. Gatze Lettinga and colleagues in the late 1970's at Wageningen University in the Netherlands.

Sludge particles are allowed to accumulate over the UASB compartment discharge pipe 42, for example, to a depth of about one third of the total depth of UASB compartment 34. Excess sludge particles may be periodically removed by suction from a conventional septic tank vacuum truck. Treated wastewater passing through the granular sludge particles are directed by head pressure to an inlet opening of UASB compartment outlet filter 46. UASB compartment 34 provides a substantially unobstructed flow for wastewater flowing between UASB discharge pipe 42 and the outlet filter 46. Outlet filter 46 can be located within USAB compartment 34 and can be of similar design to the primary treatment compartment outlet filter 30, except the filter slots may be reduced in size, for example, from about 1/16 inch to about 1/32 inch (1.6 mm to 0.8 mm) in size. Additionally or alternatively, outlet filter 46 can be an aerobic or anaerobic filter as is known in the art.

Treated wastewater is filtered through UASB compartment outlet filter 46 and exits UASB compartment 34 by flowing into UASB compartment outlet pipe 48, which is coupled to an outlet of filter 46. Outlet pipe 48 can include an interior solid baffle wall having an outlet pipe flow control orifice 50 defined therethrough. Flow control orifice 50 is sized to restrict the flow from UASB compartment 34, allowing additional detention time in system 10 and improved treatment of the wastewater. The invert of UASB compartment outlet pipe 48 is set lower than the invert of UASB compartment inlet pipe 40 to allow storage of wastewater during periods when the rate of flow into UASB compartment 34 exceeds the allowable rate of flow through outlet pipe flow control orifice 50. Treated wastewater flowing from flow control outlet orifice 50 is directed out of system 10 through treated effluent discharge pipe 52. Treated effluent from system 10 is typically discharged to a soil treatment area for additional treatment and groundwater recharge.

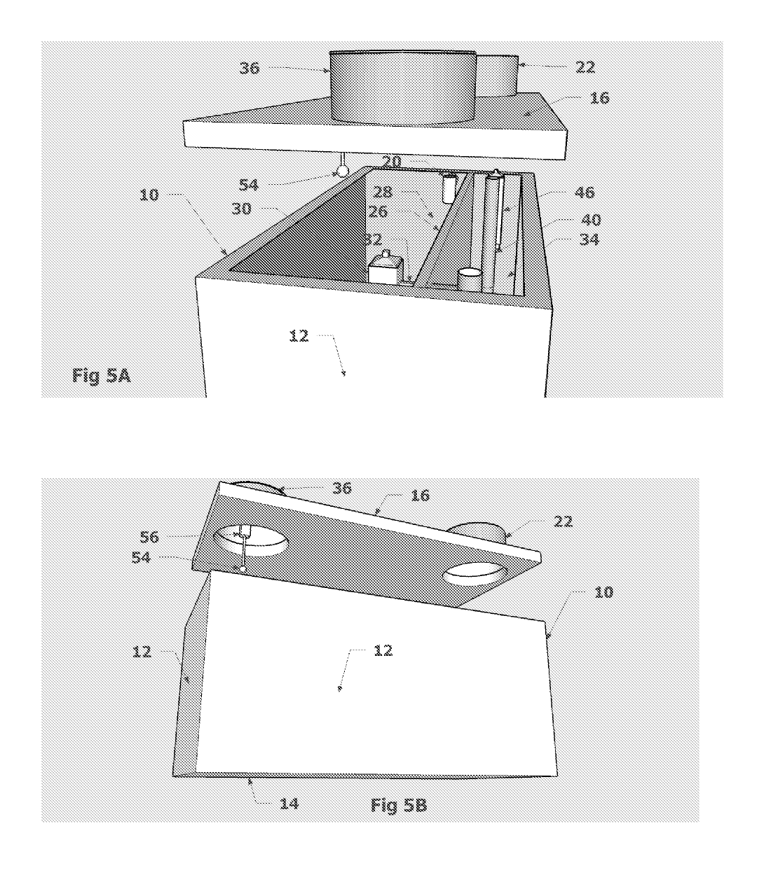

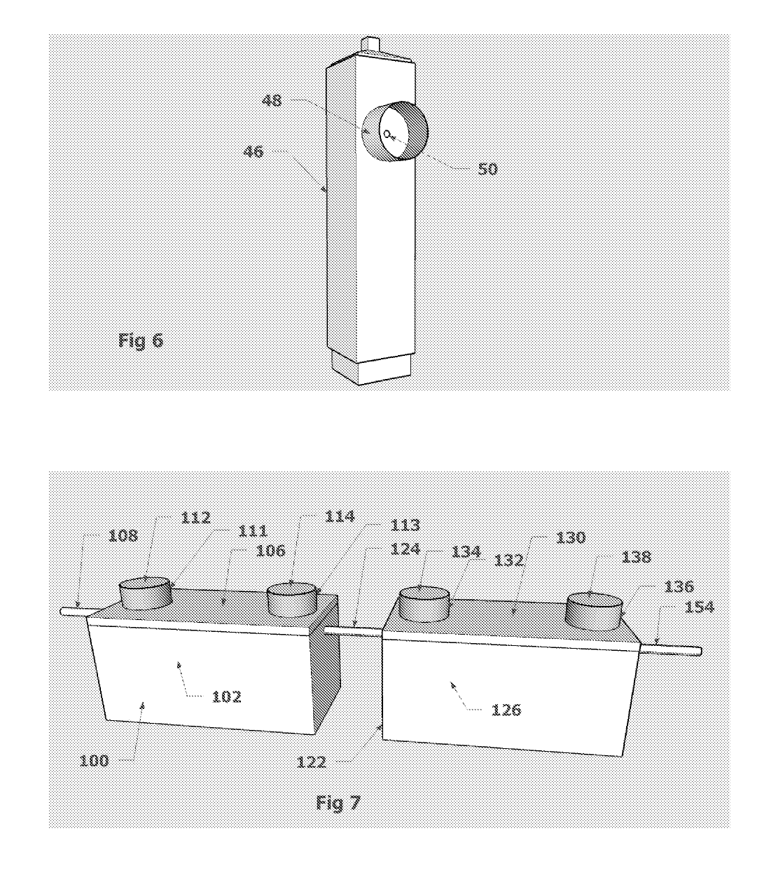

Referring to FIGS. 5A and 5B, an optional high water alarm float switch 54 is located in primary treatment compartment 28. The elevation of float switch 54 is set just above the normal operating level in primary treatment compartment 28. If the water level in primary treatment 28 becomes higher than normal, float switch 54 will close. Alarm float switch 54 is wired to high water alarm transmitter 56 which transmits an alarm signal upon float switch closure to a receiver with alarm capability located inside the owner's home. The high water alarm transmitter 56 can be powered by a replaceable battery pack. A typical alarm is a Tank Alert® ABW wireless alarm system available from SJE-Rhombus Controls of Detroit Lakes, Mich., US. The high water alarm system may also be connected to a remote monitoring source, for example, via telephone, cellular, wireless, LAN or WAN connection.

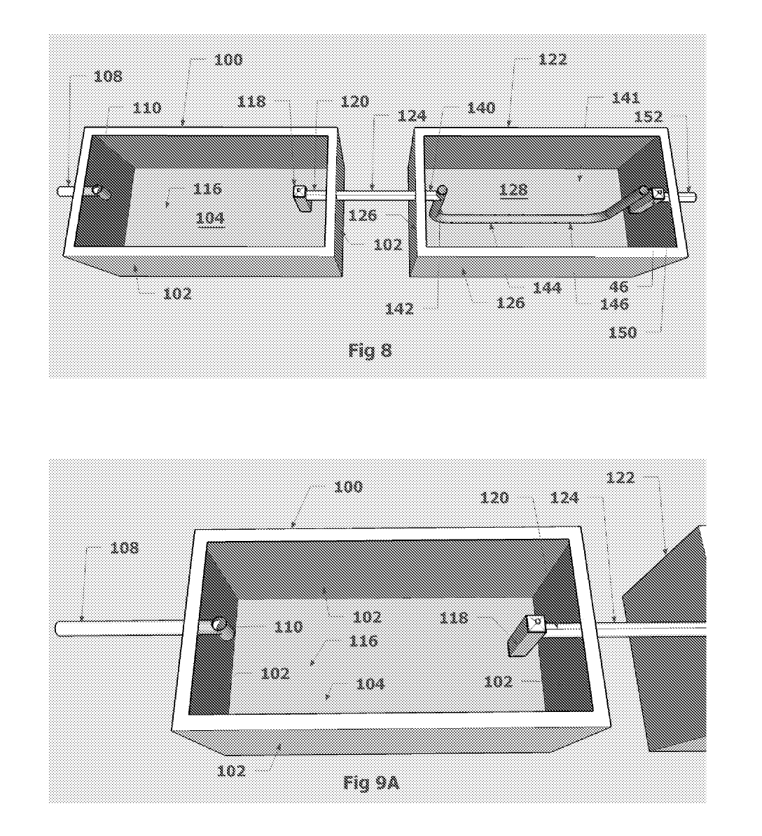

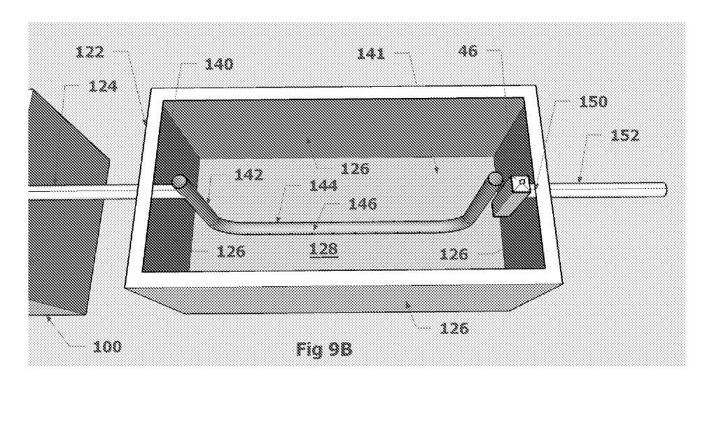

Another illustrative embodiment of a septic tank system according to the present disclosure is shown in FIGS. 7-9B. This embodiment includes a separate primary treatment tank 100 and UASB tank 122. Tanks 100 and 122 are generally installed at the site of the residence or other building, at a specified distance from the building as required by local codes or plumbing regulations. Tanks 100 and 122 are fully or substantially enclosed vessels constructed of standard septic tank materials such as precast concrete, fiberglass or plastic consisting of tank walls 102 and 126, tank bottoms 104 and 128, and tank lids 106 and 130. Tanks 100 and 122 are typically buried below grade so as to allow flow by gravity from the building to the tanks. Tank 100 generally provides the treatment function of and can include components as described for primary treatment compartment 28 of system 10. Tank 122 generally provides the treatment function of and can include the components described for UASB compartment 34 of system 10.

Domestic wastewater from the building flows into the primary treatment tank influent pipe 108 and drops through the inlet tee 110 into primary treatment basin 116. The drop depth of inlet tee 110 is sized so that the untreated wastewater enters the primary treatment basin 116 below the scum layer of fats, oils and grease, and above accumulated sludge in the bottom of the tank. An access opening and riser 111 with lid 112 is located generally over inlet tee 110 to allow access for service of the tee if it becomes clogged and to allow for evacuation pumping of the primary treatment basin 116 when required.

Wastewater flows through primary treatment basin 116 and through primary treatment basin outlet filter 118 and outlet pipe 120 in a process similar to that of primary treatment compartment 28 of system 10. An access opening and riser 113 with lid 114 is located generally over outlet filter 118 to allow access for service of the filter when it becomes clogged and to allow for pumping of the primary treatment basin 116 when required. Outlet filter 118 may be of the type described for outlet filter 30 of system 10. Treated wastewater exits the primary treatment tank 100 and is conveyed to UASB tank 122 via piping 124.

Treated wastewater enters the UASB basin 141 via the UASB tank inlet pipe 140. Inlet pipe 140 is connected to or integral with UASB basin influent pipe 142. Wastewater enters UASB basin influent pipe 142 and is transported to UASB basin discharge pipe 144 and directed out of UASB discharge pipe openings 146 using a design and in a manner similar to that of system 10. Treated effluent is directed through an outlet filter and flow control orifice of a design and in a manner similar to system 10 and is discharged to the UASB basin outlet pipe 150.

The septic tank wastewater treatment systems described herein are capable of treating domestic wastewater to a higher level than conventional septic tanks. Treatment is accomplished by initially settling the solids and floating the fats, oils and grease in the primary treatment compartment 28 or tank 100. The settled wastewater is filtered and further treated in a UASB process as described herein for UASB compartment 34 and tank 122. These two processes provide a higher quality of treatment settlement and floatation than is provided by conventional septic tanks. Since this includes an anaerobic process, the microorganisms require fairly warm temperatures to stay active and provide treatment. The tanks in both embodiments will be buried below grade and should retain enough warmth to meet the requirements of the anaerobic bacteria. In exceptionally cold climates, exterior insulation can be added to the top and sides of the tanks to keep the wastewater warm enough to provide adequate treatment.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected. For example, aspects of one illustrative embodiment may also be incorporated with any of the other illustrative embodiments disclosed herein.

1. A septic tank system (10, 100, 122) for treating wastewater, comprising:
a primary treatment compartment (28, 116) having a first inlet (18, 108) for receiving the wastewater and a first outlet (32, 120) for discharging wastewater, the primary treatment compartment adapted to separate from the wastewater therein a portion of at least one of solids and scum; and
a second treatment compartment (34, 141) having a second inlet (40, 140) and a second outlet (48, 152), the second inlet coupled to the first outlet of the primary treatment compartment;
wherein the second treatment compartment (34, 141) is adapted to provide an upflow anaerobic sludge blanket (UASB) wastewater treatment process.

2. The system of claim 1, further comprising a discharge means (42, 144) coupled to the second inlet (40, 140) and adapted to distribute wastewater adjacent a bottom portion (14, 128) of the second treatment compartment.

3. The system of claim 2, further comprising a septic tank (12, 14, 16) and wherein the first treatment compartment (28) and the second treatment compartment (34) are defined in the septic tank by at least one dividing wall (26) therebetween.

4. The system of claim 2, further comprising:
a first septic tank (100) having the first treatment compartment (116) defined therein; and
a second septic tank (122) having the second treatment compartment (141) defined therein.

5. The system of claim 2, wherein the discharge means comprises a pipe (42, 144) spanning a substantial length of the bottom portion (14, 128) of the second treatment compartment (34, 141), the pipe having an outer wall and a plurality of spaced openings (44, 146) defined through the outer wall.

6. The system of claim 5, wherein the openings (44, 146) are located at about the 3 and 9 o'clock position as viewed in a cross-section oriented perpendicular to the longitudinal axis of the pipe (42, 144).

7. The system of claim 5, wherein the pipe (42, 144) is about 3 to 4 inches (7.6 to 10.2 cm) across in cross-section perpendicular to the longitudinal axis of the pipe, and the openings (44, 146) are about ¾ to 1 inch (1.9 cm to 2.5 cm) across.

8. The system of claim 5, wherein the pipe includes a first vertical section (142), the first vertical section extended upwardly away from the bottom of the second treatment compartment and terminating at a first end positioned at a level above that of the wastewater level, the first end adapted to provide gas venting and cleaning of the pipe.

9. The system of claim 8, wherein the first end is position adjacent the second inlet of the second treatment compartment.

10. The system of claim 8, wherein the pipe includes a second vertical section at an end of the pipe opposite the first vertical section, the second vertical section extended upwardly away from the bottom of the second treatment compartment and terminating at a second end positioned at a level above that of the wastewater level, the second end adapted to provide gas venting and cleaning of the pipe.

11. The system of claim 10, wherein the second end is position proximate the second outlet of the second treatment compartment.

12. The system of claim 1, further comprising an outlet filter (30, 118) coupled to the first outlet (32, 120) of the first treatment compartment.

13. The system of claim 1, further comprising an outlet filter (46, 46) coupled to the second outlet (48, 150) of the second treatment compartment.

14. The system of claim 13, wherein the outlet filter (46) includes a flow control orifice (50).

15. The system of claim 1, further comprising a wastewater level alarm (54, 56) for at least one of the first treatment compartment and the second treatment compartment.

16. A septic tank system (10, 100, 122) for treating wastewater, comprising:
a primary treatment compartment (28, 116) having a first inlet (18, 108) for receiving the wastewater and a first outlet (32, 120) for discharging wastewater, the primary treatment compartment adapted to separate from the wastewater therein a portion of at least one of solids and scum;
a second treatment compartment (34, 141) having a second inlet (40, 140) and a second outlet (48, 152), the second inlet coupled to the first outlet of the primary treatment compartment; and
a discharge manifold (42, 144) coupled to the second inlet (40, 140) and adapted to distribute wastewater adjacent a bottom portion (14, 128) of the second treatment compartment.

17. The system of claim 16, further comprising a septic tank (12, 14, 16) and wherein the first treatment compartment (28) and the second treatment compartment (34) are defined in the septic tank by at least one dividing wall (26) therebetween.

18. The system of claim 16, further comprising:
a first septic tank (100) having the first treatment compartment (116) defined therein; and
a second septic tank (122) having the second treatment compartment (141) defined therein.

19. A septic tank system (10, 100, 122) for treating wastewater, comprising:
a primary treatment compartment (28, 116) having a first inlet (18, 108) for receiving the wastewater and a first outlet (32, 120) for discharging wastewater, the primary treatment compartment adapted to separate from the wastewater therein a portion of at least one of solids and scum;
a second treatment compartment (34, 141) having a second inlet (40, 140) and a second outlet (48, 152), the second inlet coupled to the first outlet of the primary treatment compartment;
a discharge pipe (42, 144) spanning a substantial length of the bottom portion (14, 128) of the second treatment compartment, the pipe having an outer wall and a plurality of spaced openings (44, 146) defined through the outer wall, the pipe including a first vertical section, the first vertical section (142) terminating at a first end positioned at a level above that of the wastewater level, the first end adapted to provide gas venting and cleaning of the pipe;
a first outlet filter (30, 118) coupled to the first outlet (32, 120) of the first treatment compartment (28, 116); and
a second outlet filter (46, 46) coupled to the second outlet (48, 150) of the second treatment compartment (34, 141).

20. The system of claim 19, further comprising:
a first septic tank (100) having the first treatment compartment defined therein; and
a second septic tank (122) having the second treatment compartment defined therein.
